(19) United States
(12) Patent Application Publication
(10) Pub. No.: US 2004/0042589 A1
(43) Pub. Date: Mar. 4, 2004

(54) System and method for automatically reporting call tickets

(76) Inventor: Paul C. Grooms, Alpharetta, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/231,790

(22) Filed: Aug. 29, 2002

(51) Int. Cl. H04M 1/24

(52) U.S. Cl. 379/9.03

(57) ABSTRACT

A method for reporting call tickets is disclosed. The method comprises receiving call ticket information and storing the call ticket information as a call ticket in a database. The method then receives report generation parameters and automatically generates a call ticket report based on the report generation parameters. The call ticket report is subsequently transmitted to one or more users.

### TECHNICAL FIELD

This invention relates to the field of trouble ticketing systems. More specifically, this invention relates to a system for and method of reporting call tickets.

### BACKGROUND

Computers and computer networks have become ubiquitous in businesses, schools, and homes. Computer networks provide users with sophisticated and powerful systems for efficiently processing data and providing rapid digital communication between multiple computers. Such networks include both distributed and non-distributed computing architectures across homogeneous and heterogeneous environments. With the widespread proliferation of computer networks, many tasks that were previously performed manually may now be managed via a computer network.

For example, within an organization, internal troubleshooting requests, which in the past were generally reported to an administrator directly via a conversation, note, telephone call, electronic mail, and the like, may now be reported via a network trouble ticketing application program. One such trouble ticketing program, Action Request System™marketed by Peregrine Systems of San Diego, Calif., allows users to direct their requests to the appropriate administrator(s). For instance, in large organizations, one or more administrators may be in charge of troubleshooting specific types of problems. A user may therefore enter a request to a network administrator to handle a problem associated with network connectivity, an information technology (“IT”) administrator to handle a computer hardware or software problem, or a specialized administrator to handle an area specific to the particular business (e.g., a wireless communication administrator). Thus, when a user, such as an engineer, notices any type of trouble, the user could use the trouble-ticketing program to enter a specific request for assistance to a specific administrator.

These requests are then stored in a searchable database, maintained by the trouble ticketing program, where each administrator could login and view all outstanding requests, i.e., open call tickets. Specifically, in the past, administrators would execute the trouble-ticketing program at the start of each business day to view their open and or closed call tickets.

Accordingly, in order to manage, prioritize, and complete the user's various requests, it was necessary for an administrator to execute the trouble-ticketing program. This, however, places a burden not only on the computer executing the program but also the operator. For example, each instantiation of the program as well as each query requires the use of resources such as processor load and processing time. Therefore, excessive instantiations and queries may significantly slow down or even overload the processor.

In addition, viewing open call tickets via the trouble ticketing program requires a user to provide login information as well as query information regarding the particular information desired. Moreover, once such a query is entered, the trouble-ticketing program typically displays the details of only one open call ticket per page. Thus, not only could it cost a user a significant amount of time to login and run a query, it may take a significant amount of time to parse through each open call ticket, thereby costing users considerable down time.

Additionally, administrators may at times be too busy or forget to generate reports in a timely manner, increasing the likelihood that emergency matters are not handled effectively.

Thus, a method and system for automatically and efficiently generating and transmitting call ticket reports including the details of each ticket would enhance the efficiency of computing resource usage, administrators, and the level of user satisfaction.

### SUMMARY OF THE INVENTION

In accordance with an aspect of the present invention, a method for reporting call tickets is disclosed. The method comprises receiving call ticket information. Next, the method stores the call ticket information as a call ticket in a database. The method then receives report generation parameters and automatically generates a call ticket report based on the report generation parameters. The call ticket report is subsequently transmitted to one or more users.

In accordance with another aspect of the present invention, a method for reporting call tickets is disclosed. The method comprises transmitting call ticket information and report generation parameters. Next, the method schedules a call ticket report based on the report generation parameters. The generated status report is then received by one or more users.

In accordance with yet another aspect of the present invention, a trouble ticketing system for automatically generating call ticket reports based on report generation parameters is disclosed. The trouble ticketing system comprises a receiver for receiving call ticket information and report generation parameters, a storage device for storing the call ticket information as a call ticket, a generator for automatically generating a call ticket report based on the report generation parameters, and a transmitter for transmitting the call ticket report to one or more users.

The foregoing description summarizes only a few aspects of the invention and is not intended to be indicative of the full scope of the claimed invention. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 illustrates an exemplary diagram of a networking system according to the present invention.

FIG. 2 illustrates a flowchart illustrating a method for generating and transmitting call ticket reports according to the present invention.

FIG. 3 illustrates an exemplary representation of call ticket report according to the exemplary embodiments of the present invention.

### DETAILED DESCRIPTION

Reference will now be made in detail to the present exemplary embodiments of the invention, examples of which are illustrated in the accompanying drawings. Wherever possible, the same reference numbers will be used throughout the drawings to refer to the same or like parts.

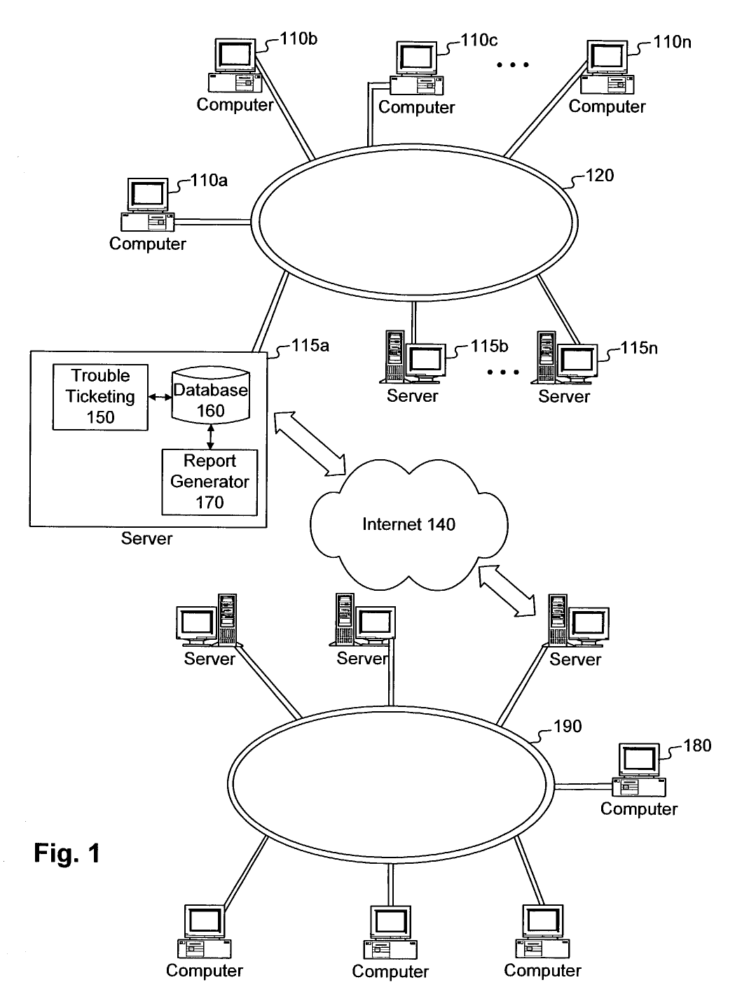

FIG. 1 illustrates a block diagram of an exemplary computing environment 100 in according to systems and methods of the present invention. While the invention will be described in the general context of an application program that runs on an operating system in conjunction with an application server, those skilled in the art will recognize that the invention may also be implemented in combination with other program modules residing on the same or other computers. Generally, program modules include programs, routines, data structures, etc. that perform particular tasks or implement particular abstract data types. Moreover, those skilled in the art will appreciate that the invention may be practiced with other computer system configurations, including hand-held devices, multiprocessor systems, and the like. The present invention may also be practiced in distributed computing environments where tasks are performed by remote processing devices that are linked through a communications network. In a distributed computing environment, program modules may be located in both local and remote memory storage devices.

The blocks illustrated in FIG. 1 may be implemented in a variety of hardware and software aspects, known to those skilled in the art. In addition, parts of the description will be presented in terms of operations performed by logical entities or computer systems under software control consistent with the manner commonly employed by those skilled in the art to convey the substance of their work to others skilled in the art. As known to those skilled in the art, these quantities take the form of electrical, magnetic, or optical signals capable of being stored, transferred, combined, and otherwise manipulated through mechanical and electrical components of a computer system; and the computer system includes general purpose as well as special purpose data processing machines, systems, and the like, that are standalone, adjunct, or embedded.

As illustrated, the networking environment 100 includes a local area network (“LAN”) 120. LAN 120 can be implemented by any industry standard networking topology, such as token ring, Ethernet, and the like. Such networking environments are widespread in offices, enterprise-wide computer networks, intranets and the Internet. While embodiments of the present invention will be described with reference to a LAN, it should be appreciated that the present invention can be practiced using other networks, such as wide-area networks or metropolitan area networks.

Still referring to FIG. 1, LAN 120 is shown connected to one or more computers 110a, 110b, 110c, . . . , 110n and one or more servers 115a, 115b. . . 115n in accordance with an embodiment of the present invention. It should be appreciated that computers 110 may be any now known or later developed computer workstation running any known operating system. For example, computers 110 may include UNIX workstations, IBM™ and/or Macintosh™ personal computers, and the like.

Computers 110 are connected to LAN 120 through a network interface, such as a network card, modem, or other means for establishing communications over the network. In a networked environment, program modules depicted relative to computers 110, or portions thereof, may be stored in a remote memory storage device. It will be appreciated that the network connections shown are exemplary and other means of establishing a communications link between the computers may be used.

While not shown, computers 110 generally include a central processing unit, a system memory, a basic input/output system (“BIOS”), and one or more disk drives, such as a hard disk drive. The drives and their associated computer-readable media provide nonvolatile storage for computers 110. A number of program modules may be stored in the drives and the system memory, including an operating system, and one or more program modules, such as a trouble-ticketing program 150 in accordance with an exemplary embodiment of the present invention. A user may enter commands and information into computers 110 through input devices, such as a keyboard, pointing device, or the like. These and other input devices are often connected to the processing unit through an interface, such as a serial port or a universal serial bus interface. A monitor or other type of display device is also generally connected to each computer 110 via an interface, such as a video adapter. In addition, computers 110 may also include other peripheral output devices, such as speakers or printers.

As shown in FIG. 1, one or more servers 115a, 115b, . . . 115n may also be connected to LAN 120. Servers 115 can be any type of computer, such as a server, a router, a peer device, or other common network node, and typically includes many or all of the elements described relative to computers 110.

For example, server 115a can be a router or gateway to a large publicly accessible wide area network, such as the Internet 140. Thus, server 115a can act as a conduit between the computers 110 and the Internet 140, as well as other computers, such as a computer 180, and networks, such as a LAN 190 through the Internet 140. Server 115a can also act as an FTP server to make selected files available to others accessing the Internet 140.

In accordance with an exemplary embodiment of the present invention, trouble-ticketing program 150 may be stored on server 115a and accessed by computers 110 via LAN 120. Trouble ticketing program 150 provides an organization the capability to administer and manage internal troubleshooting requests. For instance, in large organizations, one or more administrators may be in charge of troubleshooting specific types of problems. A user may therefore enter a request via the trouble ticketing program 150 to a network administrator to handle a problem associated with network connectivity or an IT administrator to handle a computer hardware or software problem.

It should be appreciated that the trouble ticketing program 150 may be stored on one more of the computers 110 in addition to or instead of server 115a. In one embodiment of the present invention, the trouble ticketing program 150 is a server-based program which allows the users of LAN 120 to login and request troubleshooting assistance from the appropriate administrators by creating call tickets. Once created, the call tickets may then be stored and maintained on a query-enabled database 160 associated with server 115a.

In accordance with aspects of the present invention, trouble ticketing program 150 may include various services, including: prioritizing call tickets based on the number of similar requests, the priority given the request by the user(s), and the like; tracking call tickets by the date each call ticket was opened, and automatically generating and transmitting a report of the call tickets to each administrator.

Still referring to FIG. 1, a report generator 170 is shown connected to database 160 in accordance with one embodiment of the present invention. Report generator 170 provides a method for generating one or more reports for one or more administrators. Reports may be scheduled during periods of low processor use, such as late evening to early morning. In accordance with one embodiment of the present invention, a computer program, or script, may be used to implement report generator 170. The script may include a cron daemon (e.g., using the UNIX “crontab” command) to execute the program on a periodic basis (e.g., daily or weekly). It should be appreciated that the script may be implemented in many different ways. For example, the script may independently create a predefined report using information found in database 160. Alternatively, the script may access or be incorporated into the trouble ticketing program 150, allowing trouble-ticketing program 150 to generate the desired report based on predefined parameters.

In one embodiment of the present invention, the report generator 170 may wholly or partially be implemented by a report generating application program, such as the Crystal Reports™ program marketed by Crystal Decisions Corporation of Palo Alto, Calif. It should be appreciated, however, that any reporting application program that provides interactive content from a data source might be used to implement report generator 170. While those skilled in the art will appreciate that resources may be conserved by generating reports using scripts and bypassing the overhead generated by an instance of trouble ticketing program 150 or the Crystal Reports™ program, it will likewise be appreciated that generating reports using the Crystal Reports™ program offers benefits such as ease of use and implementation.

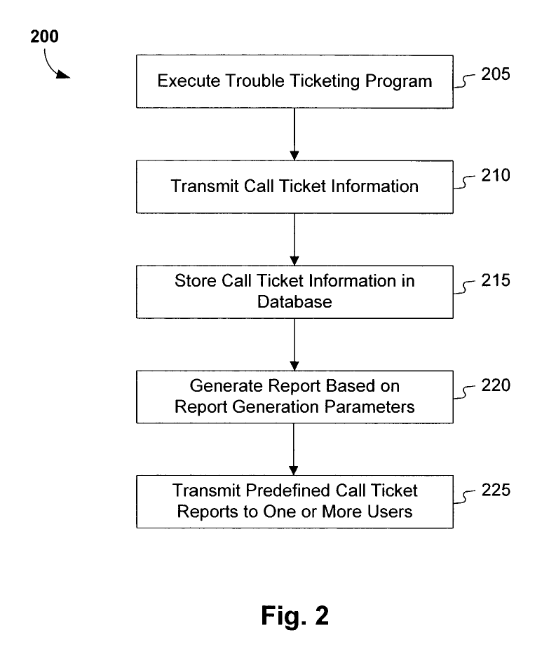

Upon executing a report, report generator 170 may transmit the report(s) to the appropriate person(s). For example, in one embodiment of the present invention, a completed report may be transmitted to a administrator using an electronic mail service. In an additional embodiment of the present invention, a completed report may be transmitted to a user via the Internet, for example, through the access of a secured website. In another embodiment of the present invention, a completed report may be transmitted to a user's mobile computing device, such as a Personal Digital Assistant (“PDA”). It should be appreciated that the reports may also be forwarded to managers or executives responsible for overseeing the administrators, allowing them to efficiently track an organization's troubleshooting efficiency. Report generator 170 will be further described below with reference to FIG. 2.

Now referring to FIG. 2, a flow chart of method 200 for generating and transmitting reports performed by report generator 170 in accordance with an exemplary embodiment of the present invention is illustrated. At stage 205, a user experiencing trouble, such as a computer or telephone malfunction or the inability to login to an application or server, opens an instant of trouble ticketing program 150. At stage 210, the user enters information regarding the problem to create a call ticket. In accordance with one embodiment of the present invention, the information may include, for example, the date of the entry, a desired repair date, the person requesting assistance, a particular administrator or department, the priority of the request, and/or a description of the problem. At stage 215, trouble ticketing program 150 populates that information in query-enabled database 160.

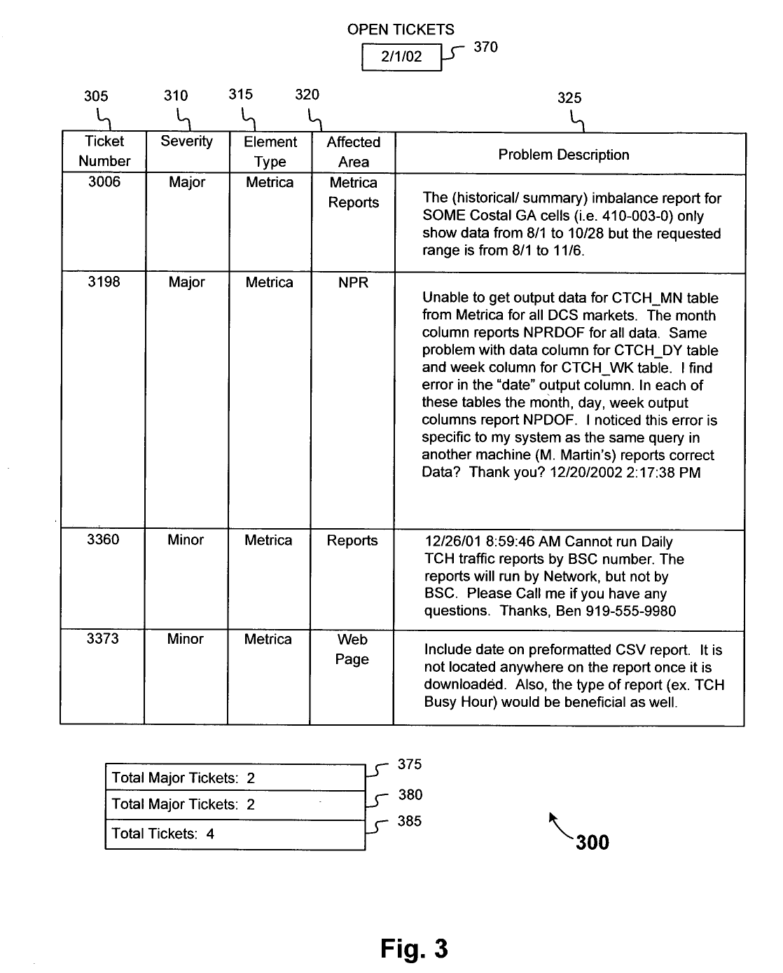

At stage 220, cell report generator 170 executes one or more predefined reports. For example, each administrator may provide report generation parameters, defining one or more reports, such as a report of all open call tickets, all open and closed call tickets, all open call tickets regarding a particular element, etc. Moreover, the reports may be individualized to include or exclude specified parameters, such as the requesting user, open date, priority information, etc. These reports may be run during times when the processor has a light load. It should be appreciated, however, that cell report generator 170 may generate reports periodically, as requested, or whenever that information becomes available. Reports generated by report generator 170 will be further described below with reference to FIG. 3.

At stage 225, the predefined reports are transmitted to the appropriate administrator(s) via any known communication medium, such as electronic mail. It should be appreciated that the reports may also be forwarded to managers or executives responsible for overseeing the administrators, allowing them to efficiently track an organization's troubleshooting efficiency.

Referring now to FIG. 3, an exemplary call ticket report 300 consistent with embodiments of the present invention will be described. C Call ticket report 300 is shown as a text file comprising various information found in database 160, organized in a table format. It should be appreciated that call ticket report 300 may be generated in any known word processing, spread sheet, or other document format, such as the PDF format. As shown, call ticket report 300 displays details regarding multiple open call tickets per page. In accordance with an exemplary embodiment of the present invention, the details may include information regarding, for example: the ticket number 305; the severity 310, or priority, of the call; the element type 315, which generally describes what system is generating a failure; the affected area 320, which describes what part of the system the failure may be impacting; and a detailed description of the problem 325. Call ticket report 300 may also include a date 370 representing the date the report was generated; the number of high priority tickets 375, the number of low priority tickets 380, and the total number of tickets reported 385.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

Moreover, although the present invention has been described above as implemented in exemplary application program modules, it will be understood that alternative embodiments will become apparent to those skilled in the art to which the present invention pertains without departing from its spirit and scope. Accordingly, the scope of the present invention is defined by the appended claims rather than the foregoing description.

What is claimed is:

1. A method for reporting call tickets comprising the steps of:
receiving call ticket information;
storing the call ticket information as a call ticket;
receiving report generation parameters;
automatically generating a call ticket report based on the report generation parameters; and
transmitting the call ticket report to a user.

2. The method of claim 1, wherein the report generation parameters include a time stamp indicating moment in time for performing the generating step.

3. The method of claim 2, wherein the generating step is performed during periods of low processor use.

4. The method of claim 1, wherein the generating step is performed by a script.

5. The method of claim 1, wherein the call ticket report is transmitted via electronic mail.

6. The method of claim 1, wherein the call ticket report is transmitted via a website.

7. The method of claim 1, wherein the call ticket report comprises information regarding a plurality of call tickets on a single page.

8. The method of claim 7, wherein the call ticket report comprises information regarding open call tickets.

9. The method of claim 1, further comprising the step of transmitting the call ticket report to a plurality of users.

10. A method for reporting call tickets comprising the steps of:
transmitting call ticket information, wherein the call ticket information is stored as a call ticket;
transmitting report generation parameters;
scheduling the generation of a call ticket report based on the report generation parameters; and
receiving the call ticket report.

11. The method of claim 10, wherein the call ticket report is scheduled to run in a period of low processor use.

12. The method of claim 10, wherein the call ticket report is transmitted via an electronic mail service.

13. The method of claim 10, wherein the call ticket report is transmitted via a website.

14. The method of claim 12, wherein the call ticket report comprises information regarding a plurality of call tickets on a single page

15. The method of claim 14, wherein the call ticket report comprises information regarding open call tickets.

16. A trouble ticketing system for automatically generating call ticket reports based on report generation parameters comprising:
a receiver for receiving call ticket information and report generation parameters;
a storage device for storing the call ticket information as a call ticket;
a generator for automatically generating a call ticket report based on the report generation parameters; and
a transmitter for transmitting the call ticket report to a user.

17. The system of claim 16, wherein the report generation parameters include the time for automatically generating the call ticket report.

18. The system of claim 17, wherein the generator generates the call ticket report during periods of low processor use.

19. The system of claim 16, wherein the generator comprises a script.

20. The system of claim 16, wherein the transmitter transmits the call ticket report via electronic mail.

21. The system of claim 16, wherein the transmitter transmits the call ticket report via a website.

22. The system of claim 16, wherein the call ticket report comprises information regarding a plurality of call tickets on a single page.

23. The system of claim 22, wherein the open call report comprises information regarding open call tickets.

24. The system of claim 16, wherein the transmitter transmits the call ticket report to a plurality of users.

25. A computer-readable medium having computer executable instructions for:
receiving call ticket information;
storing the call ticket information as a call ticket;
receiving report generation parameters;
automatically generating a call ticket report based on the report generation parameters; and
transmitting the call ticket report to a user.

26. A computer-readable medium having computer executable instructions for:
receiving call ticket information;
storing the call ticket information as a call ticket;
receiving report generation parameters;
automatically generating a call ticket report based on the report generation parameters; and
transmitting the call ticket report to a user, wherein the call ticket report comprises information regarding a plurality of call tickets on a single page.

27. A computer-readable medium having computer executable instructions for:
transmitting call ticket information, wherein the call ticket information is stored as a call ticket;
transmitting report generation parameters;
scheduling the generation of a call ticket report based on the report generation parameters; and
receiving the call ticket report.

28. A computer-readable medium having computer executable instructions for:
transmitting call ticket information, wherein the call ticket information is stored as a call ticket and via an electronic mail service;
transmitting report generation parameters;
scheduling the generation of a call ticket report based on the report generation parameters, wherein the call ticket report comprises information regarding a plurality of call tickets on a single page; and
receiving the call ticket report.
